(19) United States
(12) Patent Application Publication
(10) Pub. No.: US 2007/0139366 A1
(43) Pub. Date: Jun. 21, 2007

(54) Sharing information between devices

(76) Inventors: Gregory A. Dunko, Cary, NC (US); William M. Richey, Durham, NC (US)

Correspondence Address: HARRITY SNYDER, L.L.P., 11350 RANDOM HILLS ROAD, SUITE 600, FAIRFAX, VA, 22030, US

(21) Appl. No.: 11/312,335

(22) Filed: Dec. 21, 2005

(51) Int. Cl. G09G 5/00

(52) U.S. Cl. 345/156

(57) ABSTRACT

A mobile terminal may include a sensor to sense movement of the mobile terminal. The mobile terminal may also include logic configured to receive information from the sensor and generate motion-related information based on the received information. The mobile terminal may also include a transmitter to transmit the motion-related information to a second mobile terminal to produce an effect to a user of the second mobile terminal.

### FIELD OF THE INVENTION

The invention relates generally to communications and, more particularly, to sharing information between devices.

### BACKGROUND OF THE INVENTION

Communication devices, such as cellular telephones, have become increasingly versatile. For example, cellular telephones often include applications or programs that enable users to obtain information, such as directions to a place of interest, sports scores and weather related information. Communication devices may also include applications that allow users to play music, video games, etc. Such applications have made communication devices increasingly important to users.

### SUMMARY OF THE INVENTION

According to one aspect, a method includes sensing, by a first mobile terminal, movement of the first mobile terminal and generating, by the first mobile terminal, motion-related information associated with the sensed movement. The method also includes forwarding the motion-related information to a second mobile terminal and receiving, by the second mobile terminal, the motion-related information. The method further includes providing, by the second mobile terminal, an effect based on the processing.

In another aspect, a first mobile terminal is provided. The first mobile terminal includes at least one sensor configured to sense movement of the first mobile terminal. The first mobile terminal also includes logic configured to receive information from the at least one sensor and generate motion-related information based on the received information. The first mobile terminal also includes a transmitter configured to transmit the motion-related information to a second mobile terminal to produce an effect on the second mobile terminal.

In a further aspect, a computer-readable medium having stored sequences of instructions is provided. The instructions when executed by at least one processor cause the processor in a first mobile terminal, cause the processor to receive motion-related information from a second mobile terminal. The instructions also cause the processor to process the motion-related information and provide an impact on presentation of at least one of image information, audio information or text information to a user of the first mobile terminal based on the received motion-related information.

Other features and advantages of the invention will become readily apparent to those skilled in this art from the following detailed description. The embodiments shown and described provide illustration of the best mode contemplated for carrying out the invention. The invention is capable of modifications in various obvious respects, all without departing from the invention. Accordingly, the drawings are to be regarded as illustrative in nature, and not as restrictive.

### BRIEF DESCRIPTION OF THE DRAWINGS

Reference is made to the attached drawings, wherein elements having the same reference number designation may represent like elements throughout.

FIG. 1 is a diagram of an exemplary system in which methods and systems consistent with the invention may be implemented;

FIG. 2 is a diagram of an exemplary mobile terminal according to an implementation consistent with the invention;

FIG. 3 is a flow diagram illustrating exemplary processing by mobile terminals in an implementation consistent with the invention;

FIGS. 4A-4D illustrate exemplary output displays of a mobile terminal in accordance with implementations consistent with the invention.

FIGS. 5A-5B illustrate exemplary output displays of a mobile terminal in accordance with implementations consistent with the invention.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

Systems and methods consistent with the invention enable a communication device to sense movement or motion associated with the communication device and provides motion-related information to a second device based on the sensed motion. The second device may receive the motion-related information and may process the received information to provide an effect on the second device. The effect may include impacting presentation of information (e.g., single or multi-media information) and/or providing a sensation on the second device, such as via a vibrating mechanism, gyroscope, etc.

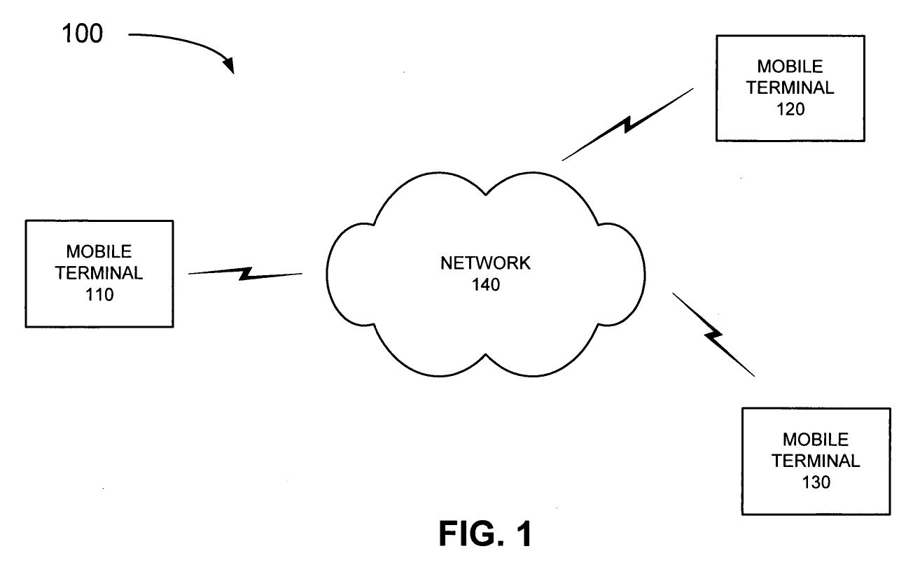

FIG. 1 is a diagram of an exemplary system 100 in which methods and systems consistent with the present invention may be implemented. System 100 may include mobile terminals 110, 120 and 130 connected via network 140. Only three mobile terminals are shown for simplicity. It should be understood that system 100 may include other numbers of mobile terminals.

The invention is described herein in the context of a mobile terminal. As used herein, the term “mobile terminal” may include a cellular radiotelephone with or without a multi-line display; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

Network 140 may include one or more networks including a cellular network, a satellite network, the Internet, a telephone network, such as the Public Switched Telephone Network (PSTN), a metropolitan area network (MAN), a wide area network (WAN), a local area network (LAN) or another type of network. Mobile terminals 110, 120 and 130 may communicate with each other over network 140 via wired, wireless or optical connections.

In one exemplary implementation, network 140 includes a cellular network that uses components for transmitting data to and from mobile terminals 110, 120 and 130. Such components may include base station antennas (not shown) that transmit and receive data from mobile terminals within their vicinity. Such components may also include base stations (not shown) that connect to the base station antennas and communicate with other devices, such as switches and routers (not shown) in accordance with conventional techniques.

In another exemplary implementation, mobile terminals 110-130 may communicate directly with one another over a relatively short distance. For example, mobile terminals 110-130 may communicate with one another using Bluetooth, infrared techniques, such as infrared data association (IrDA), etc.

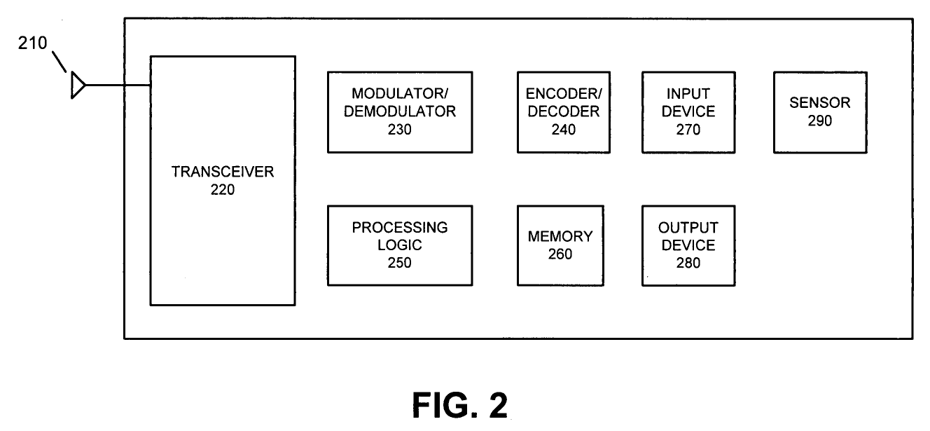

FIG. 2 is a diagram of a mobile terminal 110 according to an exemplary implementation consistent with the invention. It should be understood that mobile terminals 120 and 130 may include the same or similar elements and may be configured in the same or a similar manner.

Mobile terminal 110 may include one or more radio frequency (RF) antennas 210, transceiver 220, modulator/demodulator 230, encoder/decoder 240, processing logic 250, memory 260, input device 270, output device 280 and sensor 290. These components may be connected via one or more buses (not shown). In addition, mobile terminal 110 may include one or more power supplies (not shown). One skilled in the art would recognize that the mobile terminal 110 may be configured in a number of other ways and may include other elements.

RF antenna 210 may include one or more antennas capable of transmitting and receiving RF signals. Transceiver 220 may include components for transmitting and receiving information via RF antenna 210. In an alternative implementation, transceiver 220 may take the form of separate transmitter and receiver components, instead of being implemented as a single component. Modulator/demodulator 230 may include components that combine data signals with carrier signals and extract data signals from carrier signals. Modulator/demodulator 230 may include components that convert analog signals to digital signals, and vice versa, for communicating with other devices in mobile terminal 110.

Encoder/decoder 240 may include circuitry for encoding a digital input to be transmitted and for decoding a received encoded input. Processing logic 250 may include a processor, microprocessor, an application specific integrated circuit (ASIC), field programmable gate array (FPGA) or the like. Processing logic 250 may execute software programs or data structures to control operation of mobile terminal 110. Memory 260 may include a random access memory (RAM) or another type of dynamic storage device that stores information and instructions for execution by processing logic 250; a read only memory (ROM) or another type of static storage device that stores static information and instructions for use by processing logic 250; and/or some other type of magnetic or optical recording medium and its corresponding drive. Instructions used by processing logic 250 may also, or alternatively, be stored in another type of computer-readable medium accessible by processing logic 250. A computer-readable medium may include one or more memory devices and/or carrier waves.

Input device 270 may include any mechanism that permits an operator to input information to mobile terminal 110, such as a microphone, a keyboard, a keypad, a button, a switch, a mouse, a pen, voice recognition and/or biometric mechanisms, etc. Output device 280 may include any mechanism that outputs information to the operator, including a display, a speaker, a printer, etc. Output device 280 may also include a vibrator mechanism that causes mobile terminal 110 to vibrate.

Sensor 290 may include one or more sensors that are able to sense motion associated with mobile terminal 110. For example, sensors 290 may include one or more sensors that are able to sense the orientation of mobile terminal 110 with respect to a reference plane. For example, sensor 290 may include one or more sensors that are able to detect the orientation of mobile terminal 110 with respect to the ground. In this case, sensor 290 may be able to detect when mobile terminal 110 is tilted, when mobile terminal 110 is turned upside down such, for example, antenna 210 is facing the ground, when mobile terminal 110 is turned on its side, such that input device 270 (e.g., a keypad) is horizontal to the ground, etc. In some implementations, mobile terminal 110 may include a GPS receiver (not shown in FIG. 2) that may aid mobile terminal 110 in determining positional information associated with movement of mobile terminal 110.

Sensor 290 may also include one or more devices that is able to measure acceleration and/or velocity associated with movement of mobile terminal 110. For example, sensor 290 may include an accelerometer that is able to measure acceleration associated with mobile terminal 110 and/or a speedometer that is able to measure the speed associated with mobile terminal 110. In some implementations, mobile terminal 110 may include a GPS receiver to aid in determining speed and/or acceleration associated with movement of mobile terminal 110.

Sensor 290 may further include one or more gyroscopes (also referred to herein as gyros). A gyro may include, for example, a disk or wheel that can turn on its axis to maintain its orientation regardless of movement of mobile terminal 110. Sensor 290 may include other types of sensors associated with sensing movement or motion of mobile terminal 110.

Mobile terminals 110-130, consistent with the invention, may perform processing associated with, for example, sensing motion related information and forwarding this information to one or more other devices. Mobile terminals 110-130 may also perform processing associated with receiving motion related information from other mobile terminals. Mobile terminals 110-130 may perform these operations in response to processing logic 250 executing sequences of instructions contained in a computer-readable medium, such as memory 260. It should be understood that a computer-readable medium may include one or more memory devices and/or carrier waves. Execution of sequences of instructions contained in memory 260 causes processing logic 250 to perform acts that will be described hereafter. In alternative embodiments, hard-wired circuitry may be used in place of or in combination with software instructions to implement processes consistent with the invention. Thus, implementations consistent with the invention are not limited to any specific combination of hardware circuitry and software.

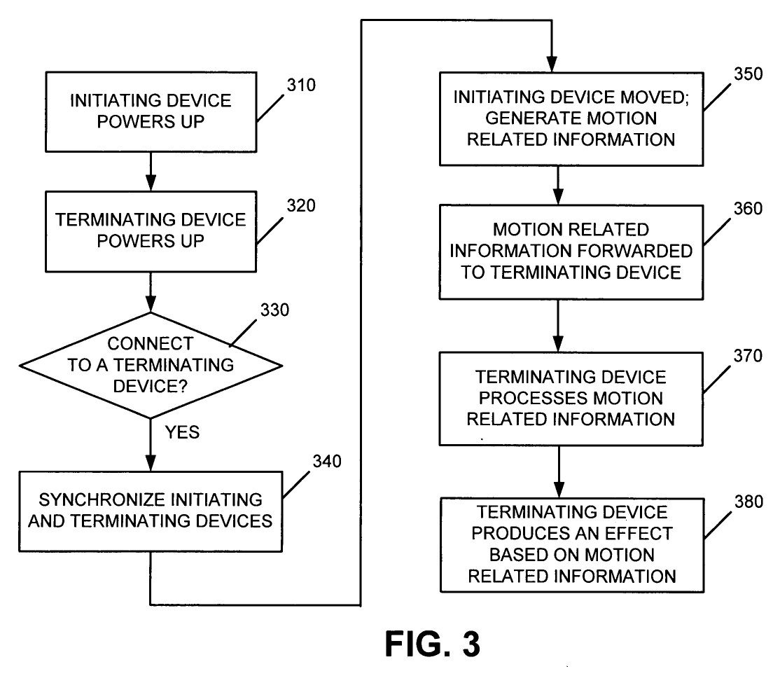

FIG. 3 is a flow diagram illustrating exemplary processing by mobile terminals in an implementation consistent with the invention. Processing may begin when a mobile terminal, such as mobile terminal 110 powers up (act 310). Mobile terminal 110, referred to herein as the initiating mobile device/terminal, as described previously, may include sensor 290 that allow mobile terminal 110 to sense and measure movement or motion as mobile terminal 110 is moved.

Assume that another mobile terminal, such as mobile terminal 120 also powers up (act 320). Mobile terminal 120, referred to herein as the terminating device/terminal, may include logic and/or sensors that allow mobile terminal 120 to act on sensed motion such that the motion of the initiating mobile terminal 120 creates an “effect” (e.g., impacts presentation of media, provides sensation to a user, etc.) on mobile terminal 120, as described in more detail below.

In an exemplary implementation, the user of mobile terminal 110 may determine whether he/she would like to connect to a terminating device (e.g., mobile terminal 120) (act 330). This may be accomplished in a number of ways. For example, the user of mobile terminal 110 may have a “buddy list” that displays other users that may be powered up. Alternatively, the user of mobile terminal 110 may send an instant message, a short message service (SMS) message, an electronic mail (email) message or another type of message to determine whether the terminating device (e.g., mobile terminal 120) is powered up.

In another implementation, the users of the initiating mobile terminal 110 and terminating mobile terminal 120 may each initiate an application program associated with sharing motion-related information with other mobile terminals. In some implementations, presence information, such as information identifying whether one or more other users (e.g., users in a buddy list) are powered up and are able to connect with mobile terminal 110 or mobile terminal 120 (e.g., via a short range or via a network), may indicate that these other users/mobile terminals are capable of processing motion-related information. Each of the users may initiate the application program via, for example, input device 270 (FIG. 2), which may include pressing a control button or keypad input on each of their respective mobile terminals. In this implementation, mobile terminals 110 and 120 may each be executing the same application, such as a video game, or a matched application that allows users to share information.

In some implementations, if both devices are powered up and the user of initiating mobile terminal 110 wishes to connect to terminating mobile terminal 120, mobile terminals 110 and 120 may perform a synchronization procedure (act 340). That is, mobile terminals 110 and 120 may exchange information to facilitate communications between themselves. In other implementations, no synchronization may be needed.

In either case, mobile terminal 110 may connect to mobile terminal 120. In an exemplary implementation, mobile terminals 110 and 120 may be located in relatively close proximity to each other and may connect over the short range utilizing, for example, Bluetooth, IrDA, etc. Alternatively, the connection of mobile terminals 110 and 120 may be over distant connections via network 140, such as via a cellular or mobile network.

As discussed previously, the connection between mobile terminals 110 and 120 may involve each of mobile terminals 110 and 120 executing the same application or a shared application, such as when users of mobile terminals 110 and 120 are playing a video game with each other or against each other. In this case, the output device 280 of each mobile terminal may include a display screen that displays the same images at the same time or substantially the same time. Alternatively, the output device 280 of each mobile terminal may display similar scenes from different perspectives. For example, in a shared video game application, each output device 280 may display a scene from the perspective of that particular player in the game, such that one player may view the other player and vice versa. In each case, the display screens of mobile terminals 110 and 120 may be synchronized based on the particular application.

Assume that initiating mobile terminal 110 is moved (act 350). That is, the user of initiating mobile terminal 110 moves mobile terminal 110. For example, the user of initiating mobile terminal 110 may turn mobile terminal 110 upside down, on its side, etc. Sensor 290 may sense this movement and generate motion-related information that describes or quantifies this motion (act 350). For example, mobile terminal 110 may generate X, Y, Z, positional information with respect to a reference X plane, Y plane and Z plane. Initiating terminal 110 may send the motion-related information to terminating mobile terminal 120 (act 360).

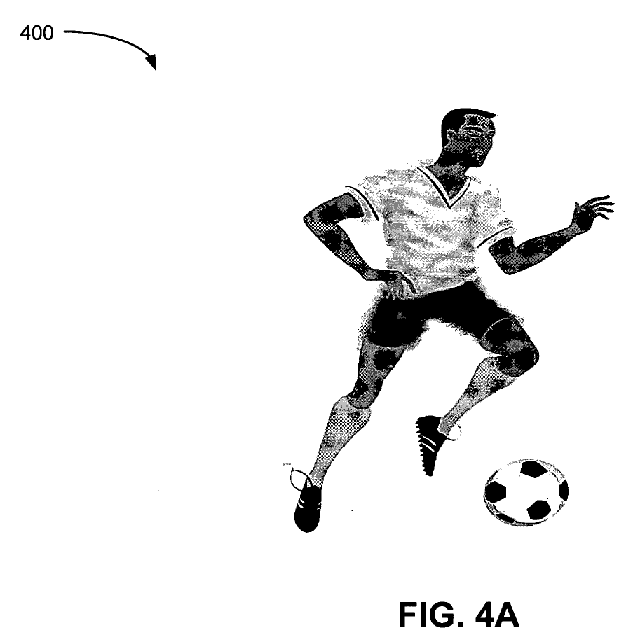

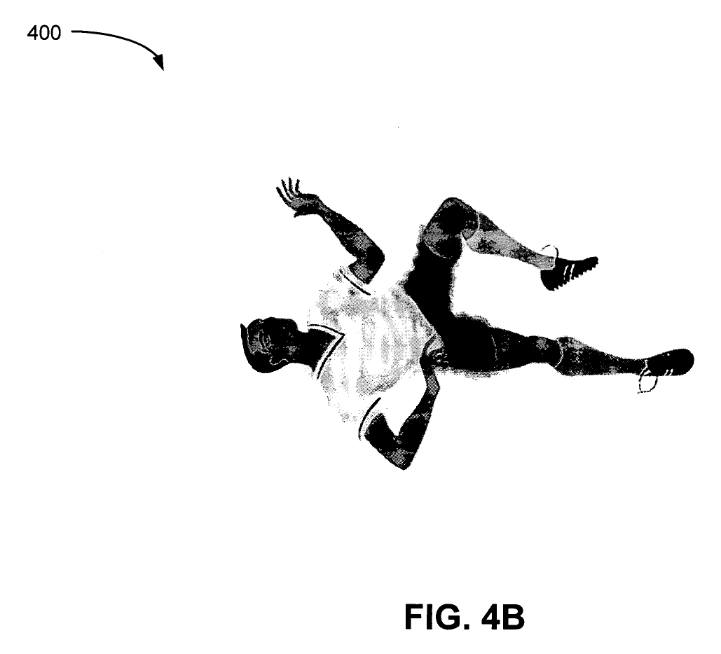

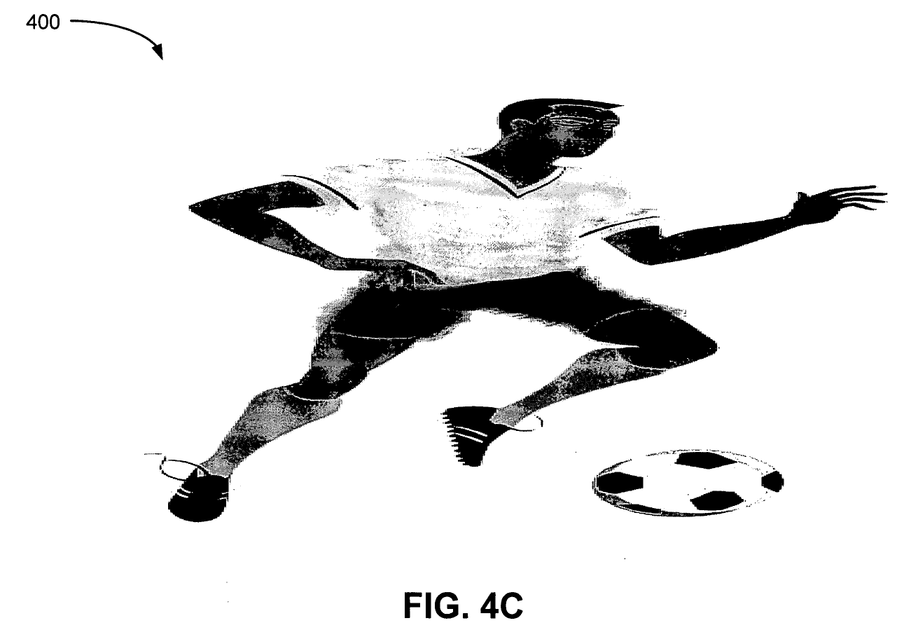

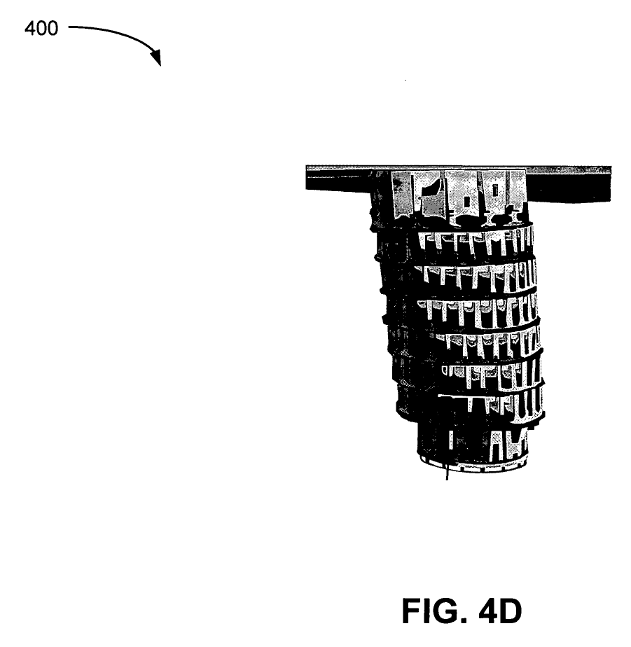

Terminating mobile terminal 120 may receive the motion-related information and process this information (act 370). For example, processing logic 250 of mobile terminal 120 may process the received information to determine how mobile terminal 110 has been moved. Terminating mobile terminal 120 may then act on the processed motion-related information such that the received information creates an effect on mobile terminal 120 (act 380). For example, in an exemplary implementation, mobile terminal 120 may modify an output displayed on output device 280 of mobile terminal 120. For example, assume that the users of mobile terminal 110 and 120 are playing a video game against each other, such as a soccer game. Assume that display of mobile terminal 110 shows a soccer player with a ball, as illustrated in display 400 in FIG. 4A. Further, assume that mobile terminal 120 receives information from mobile terminal 110 that indicates that mobile terminal 110 was turned on its side (e.g., its keypad is horizontal to the ground). Processing logic 250 of mobile terminal 120 may then process the received information and modify output display 400 to show that the soccer player has fallen down and has lost the ball, as illustrated in FIG. 4B.

In other implementations, mobile terminal 120 may receive speed or acceleration related information from mobile terminal 110. In this case, processing logic 250 of mobile terminal 120 may increase the speed of one or more players/characters (e.g., a soccer player) displayed in an output screen for a video game being played by the user of mobile terminal 120.

In still other alternatives, a display of mobile terminal 120 may be modified in other ways. For example, one or more images output by mobile terminal 120 to a display screen may be distorted by elongating/stretching images in the display. For example, FIG. 4C illustrates an output display 400 in which the width of the soccer player is made wider. This may occur in response to the user of mobile terminal 110 spinning or flipping mobile terminal 110 or making some other predetermined movement. In another example, an output display may flip an image upside down based on mobile terminal 110 being turned upside down. In this case, an output display, such as display 400 may turn the image of, for example, the Leaning Tower of Pisa displayed by mobile terminal 120 upside down, as illustrated in FIG. 4D.

In another exemplary implementation, assume that users of mobile terminals 110 and 120 are communicating via, for example, an instant messaging (IM) session with images of each other (or representative image icons) being displayed on mobile terminals 110 and 120 during the IM session. Further assume that the user of mobile terminal 110 turns/rotates mobile terminal 110 in a back and forth motion. In this implementation, mobile terminal 110 may send information associated with this movement of mobile terminal 110 to mobile terminal 120. Mobile terminal 120 may receive the motion-related information and may modify an image displayed on mobile terminal 120. For example, mobile terminal 120 may modify an image/icon representing the user of mobile terminal 110 to show that the image/icon is shaking its head to indicate “No”. If the motion of mobile terminal 110 is an up/down motion, mobile terminal 120 may show the image/icon nodding its head to indicate “Yes”. Alternatively, if mobile terminal 110 is moved in a fast, violent manner, the image/icon displayed on mobile terminal 120 may change from a happy image to an angry image.

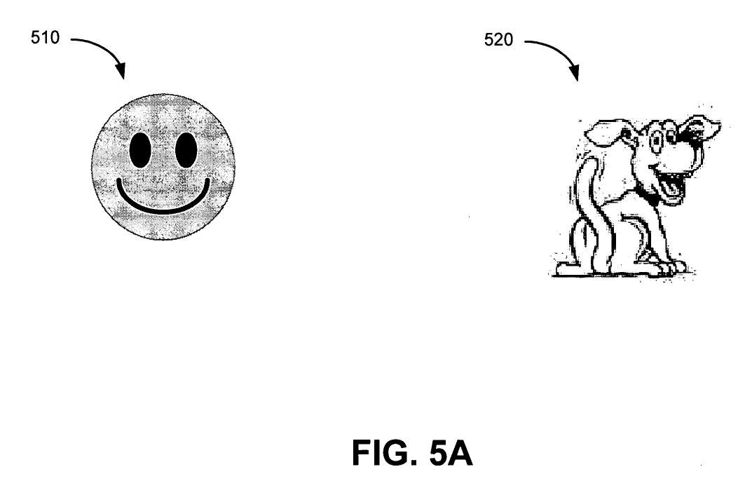

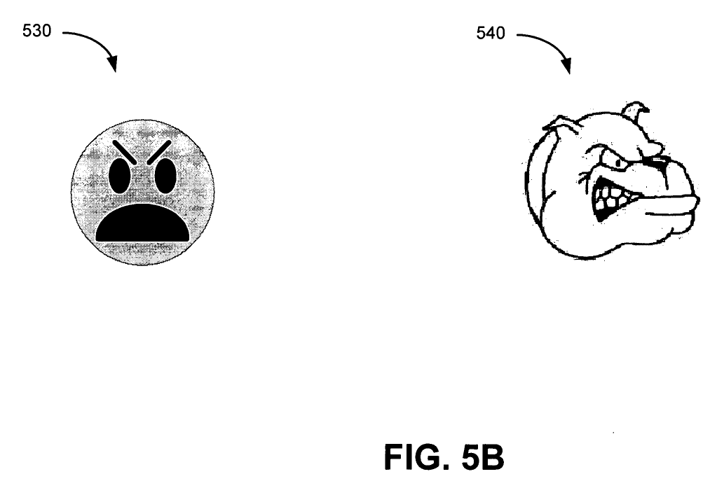

For example, FIG. 5A illustrates exemplary images 510 and 520 that may be displayed on mobile terminal 120. As illustrated, image 510 is a smiling face and image 520 is a dog wagging its tail. After mobile terminal 110 is moved in a predetermined manner (e.g., rotated back and forth in a fast, violent manner) and mobile terminal 120 receives motion-related information from mobile terminal 110 associated with this motion, exemplary image 510 may be modified to display image 530, as illustrated in FIG. 5B. Alternatively, if image 520 is being used in the IM session, image 520 may be modified to display image 540. Images 530 and 540, as illustrated in FIG. 5B, are an angry face image and an angry dog image, respectively. In this manner, icons/images may be provided or modified based on the particular motion of mobile terminal 110. The motions that result in the particular images displayed to another user may be set based on the particular application and may be known to users of mobile terminals 110 and 120.

As another example, suppose that two joggers are running by themselves. Assume that one jogger is carrying mobile terminal 110 and the other jogger is carrying mobile terminal 120 and that mobile terminals 110 and 120 are linked to each other. Further assume that the jogger associated with mobile terminal 110 increases his/her running speed. Sensor 290 may sense the increase in speed of mobile terminal 110 and may forward this information to mobile terminal 120. In this case, the display of mobile terminal 120 may provide a visual indication that the first jogger (i.e., the jogger carrying mobile terminal 110) has sped up. The visual indication may include velocity/pace information corresponding to the speed of the first jogger and/or an icon/image representing an increased speed. Alternatively, mobile terminal 120 may provide more indirect feedback, such as increasing the speed of music being played on mobile terminal 120, increasing the volume of music played on mobile terminal 120, etc. In this manner, the joggers carrying mobile terminals 110 and 120 may interact with each other without having to manually place a call.

In still another alternative, sensor 290, as described above, may include one or more gyros. In this case, as mobile terminal 110 moves, sensor 290 may forward information from its gyro(s) to mobile terminal 120. Mobile terminal 120 may also include one or more gyros. In this case, processing logic 250 of mobile terminal 120 may receive and process the gyro-related information and produce an effect in which the user of mobile terminal 120 senses a tilted effect with respect to mobile terminal 120. That is, the gyros of mobile terminal 120 may produce an effect as if mobile terminal 120 is being moved and/or tilted. In this manner, movement of mobile terminal 110 may be felt by a user holding mobile terminal 120. In another alternative, movement of mobile terminal 110 may be felt by a user holding mobile terminal 120 by activating a vibrator mechanism or some other mechanism that provides sensory input to the user of mobile terminal 120.

In each case, motion sensed by mobile terminal 110 may be forwarded to mobile terminal 120. Mobile terminal 120 may then produce an effect that may be observed and/or felt by the user of mobile terminal 120.

Although not described above, mobile terminal 120 may also be able to sense motion associated with mobile terminal 120 and forward the motion-related information to another mobile terminal, such as mobile terminal 110. Mobile terminal 110 may then produce an effect that may be observed and/or felt by the user of mobile terminal 110. In this manner, users of mobile terminals 110 and 120 may share information in an interactive two-way manner.

### CONCLUSION

Implementations consistent with the invention allow users to share motion-related information. A receiving device may then process the information to produce an effect that may be observed and/or felt by a party associated with the receiving device. The effect may include, for example, providing an impact on presentation of information (e.g., single or multi-media information) to the receiving device and/or providing a sensation on the receiving device, such as via a vibrating mechanism, gyroscope, etc. Sharing information in this manner may help provide another way to enhance a user's experience with respect to using a mobile terminal.

The foregoing description of the embodiments of the present invention provides illustration and description, but is not intended to be exhaustive or to limit the invention to the precise form disclosed. Modifications and variations are possible in light of the above teachings or may be acquired from practice of the invention.

For example, the invention has been mainly described in the context of a mobile terminal sharing motion-related information in a shared application. The invention, however, may be used to modify other types of information. For example, digital pictures displayed by a first mobile terminal may be modified and/or distorted based on motion of a second mobile terminal. Other types of information, such as multi-media information (e.g., one or more of image, music or text), may also be modified and/or distorted in implementations consistent with the invention.

In addition, the invention has been described in the context of mobile terminals sharing information. The invention may also be implemented by any network device, including a non-mobile device that is able to connect to a network. In this case, one or more sensors located externally from the non-mobile device may be used to sense motion and this information may be provided to another device.

Further, while series of acts have been described with respect to FIG. 3, the order of the acts may be varied in other implementations consistent with the present invention. No element, step, or instruction used in the description of the present application should be construed as critical or essential to the invention unless explicitly described as such.

It will also be apparent to one of ordinary skill in the art that aspects of the invention, as described above, may be implemented in cellular communication devices/systems, methods, and/or computer program products. Accordingly, the invention may be embodied in hardware and/or in software (including firmware, resident software, micro-code, etc.). Furthermore, the invention may take the form of a computer program product on a computer-usable or computer-readable storage medium having computer-usable or computer-readable program code embodied in the medium for use by or in connection with an instruction execution system. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as an application specific integrated circuit or a field programmable gate array, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

The scope of the invention is defined by the claims and their equivalents.

What is claimed is:

1. A method, comprising:
sensing, by a first mobile terminal, movement of the first mobile terminal;
generating, by the first mobile terminal, motion-related information associated with the sensed movement;
forwarding the motion-related information to a second mobile terminal;
receiving, by the second mobile terminal, the motion-related information; and
providing, by the second mobile terminal, an effect based on the received motion-related information.

2. The method of claim 1, wherein the providing an effect comprises:
modifying at least a portion of information being presented to a user of the second mobile terminal.

3. The method of claim 2, wherein the modifying includes at least one of providing flipping, tilting or distorting an image on a display associated with the second mobile terminal.

4. The method of claim 2, wherein the modifying includes at least one of changing a speed or acceleration of an image being displayed to a user of the second mobile terminal.

5. The method of claim 1, wherein the providing an effect comprises:
providing an impact on presentation of information to a user of the second mobile terminal, the information including at least one of image information, audio information or text information.

6. The method of claim 1, wherein the providing an effect comprises:
providing an effect using a gyroscope.

7. The method of claim 1, further comprising:
playing, by the first and second mobile terminals, a video game, wherein the providing an effect comprises:
modifying an output of the video game based on the motion-related information.

8. The method of claim 1, further comprising:
sensing, by the second mobile terminal, movement of the second mobile terminal;
generating, by the second mobile terminal, motion-related information associated with the movement of the second mobile terminal;
forwarding the motion-related information to the first mobile terminal;
receiving, by the first mobile terminal, the motion-related information from the second mobile terminal;
processing, by the first mobile terminal, the received motion-related information; and
providing, by the first mobile terminal, an effect based on the processing.

9. The method of claim 8, wherein the providing an effect by the first mobile terminal comprises:
providing an effect to a user of the first mobile terminal using a gyroscope.

10. The method of claim 8, wherein the providing an effect by the first mobile terminal comprises:
providing an impact on presentation of information presented to a user of the first mobile terminal, the information including at least one of image information, audio information or text information.

11. The method of claim 1, wherein the forwarding comprises:
transmitting the motion-related information using at least one of Bluetooth or infrared communications.

12. The method of claim 1, wherein the forwarding comprises:
transmitting the motion-related information using a cellular network.

13. A first mobile terminal, comprising:
at least one sensor configured to:
sense movement of the first mobile terminal;
logic configured to:
receive information from the at least one sensor, and
generate motion-related information based on the received information;
and
a transmitter configured to:
transmit the motion-related information to a second mobile terminal to produce an effect on the second mobile terminal.

14. The first mobile terminal of claim 13, wherein the effect on the second mobile terminal comprises:
impacting presentation of at least one of image information, audio information or text information to a user of the second mobile terminal.

15. The first mobile terminal of claim 13, further comprising:
a display; and
a receiver configured to receive motion-related information from the second mobile terminal, wherein the logic is further configured to:
modify at least one of image information, audio information or text information presented to a user of the first mobile terminal based on the received motion-related information.

16. The first mobile terminal of claim 15, wherein when modifying at least one of image information, audio information or text information, the logic is configured to:
at least one of provide an image, flip an image, tilt an image or distort an image on the display.

17. The first mobile terminal of claim 15, wherein when modifying at least one of image information, audio information or text information, the logic is configured to:
change at least one of a speed or acceleration of an image on the display.

18. The first mobile terminal of claim 15, wherein when modifying at least one of image information, audio information or text information, the logic is configured to:
change a speed of audio information provided to a user of the first mobile terminal.

19. The first mobile terminal of claim 13, wherein the first and second mobile terminals are configured to execute a shared application and the logic is further configured to:
modify output from the shared application based on motion-related information received from the second mobile terminal.

20. The first mobile terminal of claim 13, wherein the transmitter is configured to transmit the motion-related information using Bluetooth.

21. The first mobile terminal of claim 13, wherein the transmitter is configured to transmit the motion-related information using infrared communications.

22. The first mobile terminal of claim 13, wherein the transmitter is configured to transmit the motion-related information using a cellular network.

23. The first mobile terminal of claim 13, wherein the at least one sensor comprises at least one of a speedometer, an accelerometer, a gyroscope or a detector configured to detect an orientation of the first mobile terminal.

24. A computer-readable medium having stored thereon a plurality of sequences of instructions, said sequences of instructions including instructions which, when executed by at least one processor in a first mobile terminal, cause the processor to:
receive motion-related information from a second mobile terminal;
process the motion-related information; and
provide an impact on presentation of at least one of image information, audio information or text information to a user of the first mobile terminal based on the received motion-related information.

25. The computer-readable medium of claim 24, wherein when providing an impact on presentation of at least one of image information, audio information or text information to a user of the first mobile terminal, the instructions cause the processor to:
at least one of provide an image, flip an image, tilt an image or distort an image on a display associated with the first mobile terminal.

26. The computer-readable medium of claim 24, wherein when providing an impact on presentation of at least one of image information, audio information or text information to a user of the first mobile terminal, the instructions cause the processor to:
at least one of change a speed of an image on a display associated with the first mobile terminal or change a speed of music played by the first mobile terminal.

27. The computer-readable medium of claim 24, further comprising instructions for causing the processor to:
receive information from at least one sensor when the first mobile terminal is moved;
generate second motion-related information based on the information received from the at least one sensor; and
forward the second motion-related information to the second mobile terminal, wherein the second motion-related information impacts presentation of information provided to a user of the second mobile terminal.

28. A first network device, comprising:
means for sensing movement of the first network device;
means for generating first motion-related information associated with the sensed movement;
means for forwarding the first motion-related information to a second network device, wherein the first motion-related information produces an effect on the second network device;
means for receiving second motion-related information from the second network device;
means for processing the second motion-related information; and
means for modifying presentation of information provided by the first network device based on the second motion-related information.
